(19) United States
(12) Patent Application Publication
(10) Pub. No.: US 2026/0155494 A1
(43) Pub. Date: Jun. 4, 2026

(54) SECONDARY BATTERY AND METHOD OF MANUFACTURING SECONDARY BATTERY

(71) Applicant: SAMSUNG SDI CO., LTD., Yongin-si (KR)

(72) Inventor: Taewoong JANG, Yongin-si (KR)

(21) Appl. No.: 19/226,402

(22) Filed: Jun. 3, 2025

(30) Foreign Application Priority Data
Dec. 4, 2024 (KR) 10-2024-0178688

(51) Int. Cl. H01M 50/109; H01M 4/04; H01M 10/04; H01M 50/121; H01M 50/463; H01M 50/54

(52) U.S. Cl. CPC H01M 50/109; H01M 4/043; H01M 10/0427; H01M 10/0477; H01M 50/121; H01M 50/463; H01M 50/54

(57) ABSTRACT

A secondary battery includes a case and an electrode assembly accommodated in the case. The electrode assembly includes a first electrode, a separator, and a second electrode. An insulating member is positioned between the electrode assembly and the case. The first electrode includes a pair of first double layers each including a first substrate and a first coating layer disposed on the first substrate, and a first center substrate positioned between the pair of first double layers. The second electrode includes a pair of second double layers each including a second substrate and a second coating layer disposed on the second substrate, and a second center substrate positioned between the pair of second double layers.

### CROSS-REFERENCE TO RELATED APPLICATION

The present application claims priority to and the benefit of Korean Application No. 10-2024-0178688, filed on Dec. 4, 2024, in the Korean Intellectual Property Office, the entire disclosure of which is incorporated by reference herein.

### BACKGROUND

### Field

The present disclosure relates to a secondary battery and a method of manufacturing a secondary battery.

### Description of the Related Art

A secondary battery is a rechargeable battery that may be charged and discharged multiple times. Secondary batteries are used in various applications, such as electronic devices (smartphones, laptops, tablets, etc.), electric vehicles, solar power generation, and emergency power supplies. In particular, lithium-ion batteries that have high energy density and high charge-discharge efficiency are used various electronic devices and electric vehicles.

Demand has increased for wearable devices that use wireless communication such as BLUETOOTH®, for example, headphones, earphones, smartwatches, and body-attachable medical devices. There is a growing need for micro-sized secondary batteries to be mounted in wearable devices.

However, in manufacturing micro-sized, stacked-type secondary batteries, a significant loss of electrode plates may occur during the manufacturing process. Such electrode plate loss may result in deterioration in yield and economic efficiency. Thus, there is a need for manufacturing a micro-sized, stacked-type secondary battery that reduce electrode plate loss.

The above information disclosed in this section is for enhancement of understanding of the background of the present disclosure and may contain information that does not constitute related or prior art.

### SUMMARY

An aspect of the present disclosure is to provide a secondary battery and a method of manufacturing a secondary battery.

These and other aspects and features of the present disclosure will be described in or will be apparent from the following description of embodiments of the present disclosure.

According to embodiments of the present disclosure, a secondary battery may include a case, an electrode assembly accommodated in the case, the electrode assembly including a first electrode, a separator, and a second electrode, and an insulating member positioned between the electrode assembly and the case, wherein the first electrode may include a pair of first double layers each including a first substrate and a first coating layer disposed on the first substrate, and a first center substrate positioned between the pair of first double layers, and wherein the second electrode may include a pair of second double layers each including a second substrate and a second coating layer disposed on the second substrate, and a second center substrate positioned between the pair of second double layers.

According to some embodiments of the present disclosure, the first center substrate may include a first electrode tab extending from an end of the first center substrate, and wherein the second center substrate may include a second electrode tab extending from an end of the second center substrate.

In some embodiments, the first center substrate may include an insulating portion in which a polyimide (PI) film is coated on a part of the first electrode tab.

In some embodiments, each of the first electrode, the second electrode, and the separator is circular shaped.

In some embodiments, each of the first electrode and the second electrode has a surface area that is less than a surface area of the separator.

In some embodiments, the first center substrate may include a first linear segment on one side, wherein the second center substrate may include a second linear segment on one side, wherein the first electrode tab is positioned to the first segment, and wherein the second electrode tab is positioned to the second segment.

In some embodiments, a central angle formed between of the first segment and the second segment is 60° to 90°.

In some embodiments, the first electrode tab and the second electrode tab extend in opposite directions with respect to the first center substrate and the second center substrate.

In some embodiments, the first electrode tab and the second electrode tab extend in the same direction with respect to the first center substrate and the second center substrate.

In some embodiments, the first electrode, the separator, and the second electrode are stacked in a first direction, and wherein the first electrode tab and the second electrode tab extend in a second direction that is perpendicular to the first direction.

In some embodiments, the electrode assembly is a stack-type electrode assembly, and wherein the separator is positioned between the first coating layer of the first electrode and the second coating layer of the second electrode.

In some embodiments, the first coating layer is disposed on first surfaces of the first substrates and the second coating layer is disposed on first surfaces of the second substrate, wherein the first center substrate is positioned between second surfaces of the first substrates, and wherein the second center substrate is positioned between second surfaces of the second substrates.

In some embodiments, a thickness of the center substrate is less than a thickness of the first substrate and a thickness of the second substrate.

In some embodiments, the secondary battery is a coin-type secondary battery or a button-type secondary battery.

In some embodiments, a method for manufacturing a secondary battery, may include forming an electrode assembly by stacking a first electrode, a separator, and a second electrode, attaching an insulating member to the electrode assembly, and disposing the electrode assembly with the attached insulating member in a case. The first electrode may include a pair of first double layers each including a first substrate and a first coating layer disposed on the first substrate, and a first center substrate positioned between the pair of first double layers. The second electrode may include a pair of second double layers each including a second substrate and a second coating layer positioned on the second substrate, and a second center substrate disposed between the pair of second double layers.

In some embodiments, the first center substrate may include a first electrode tab extending from an end of the first center substrate, and wherein the second center substrate may include a second electrode tab extending from an end of the second center substrate.

In some embodiments, forming the electrode assembly may include preparing an electrode plate by forming the first coating layer on the first substrate, and punching the electrode plate to form the pair of first double layers having a circular shape.

In some embodiments, preparing the first electrode plate may include cutting the electrode plate to prepare the first electrode plate having the first coating layer.

In some embodiments, forming the electrode assembly may include preparing a second electrode plate by forming the second coating layer on the second substrate, and punching the second electrode plate to form the pair of second double layers having a circular shape.

In some embodiments, forming the electrode assembly may include preparing a third electrode plate on which no coating layer is formed, and punching the third electrode plate to form the first center substrate and the second center substrate.

According to embodiments of the present disclosure, because electrode plate loss is reduced during the manufacturing process of a micro-sized, stacked-type secondary battery, the manufacturing efficiency of the secondary battery may be improved.

According to embodiments of the present disclosure, the manufacturing process of the micro-sized, stacked-type secondary battery may be simplified, and defects generated by the process of coating active material on a substrate may be reduced.

According to embodiments of the present disclosure, by means of the shape of the electrode assembly, damage caused by contact between the electrode assembly and the case may be prevented, and the energy density of the electrode assembly may be improved compared to conventional electrode assemblies.

However, aspects and features of the present disclosure are not limited to those described above, and other aspects and features not mentioned will be clearly understood by one skilled in the art from the following detailed description.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a perspective view of a secondary battery according to some embodiments of the present disclosure.

FIG. 2 is an exploded perspective view of a secondary battery according to some embodiments of the present disclosure.

FIG. 3 illustrates a manufacturing process of a secondary battery according to a comparative example.

FIG. 4 illustrates a manufacturing process of a secondary battery according to embodiments of the present disclosure.

FIGS. 5 and 6 are cross-sectional views of an electrode assembly according to embodiments of the present disclosure.

FIG. 7 is a top plan view of an electrode assembly according to a first embodiment of the present disclosure.

FIG. 8 is a top plan view of an electrode assembly according to a second embodiment of the present disclosure.

FIG. 9 is ac top plan view of an electrode assembly according to embodiments of the present disclosure.

FIG. 10 is a perspective view of a secondary battery according to embodiments of the present disclosure.

FIG. 11 is a flowchart of a method of manufacturing a secondary battery according to embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that an inventor may be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that may replace or modify the embodiments described herein at the time of filing this application.

It will be understood that when an element or layer is referred to as being “on,” “connected to,” or “coupled to” another element or layer, it may be directly on, connected, or coupled to the other element or layer, or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element, or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C,” “at least one of A, B or C,” “at least one selected from a group of A, B and C,” or “at least one selected from among A, B and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein includes all sub-ranges of the same numerical precision subsumed within the recited range. For example, a range of “1.0 to 10.0” includes all subranges between (and including) the recited minimum value of 1.0 and the recited maximum value of 10.0, that is, having a minimum value greater than or equal to 1.0 and a maximum value less than or equal to 10.0, such as, for example, 2.4 to 7.6. Any maximum numerical limitation recited herein includes all lower numerical limitations subsumed therein, and any minimum numerical limitation recited in this specification includes all higher numerical limitations subsumed therein. Accordingly, Applicant reserves the right to amend this specification, including the claims, to expressly recite any sub-range subsumed within the ranges expressly recited herein. All such ranges are inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a situation having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an element “above (or below)” or “on (under)” another element may mean that the element may be disposed in contact with the upper (or lower) surface of the element, or another element may also be interposed between the element and the element disposed on (or under) the element.

In addition, it will be understood that when a component is referred to as being “linked,” “coupled,” or “connected” to another component, the elements may be directly “coupled,” “linked,” or “connected” to each other, or another component may be “interposed” between the components.

Throughout the specification, when “A and/or B” is stated, it means A, B, or A and B, unless otherwise stated. That is, “and/or” includes any or all combinations of a plurality of items enumerated. When “C to D” is stated, it means greater than or equal to C and less than or equal to D, unless otherwise specified.

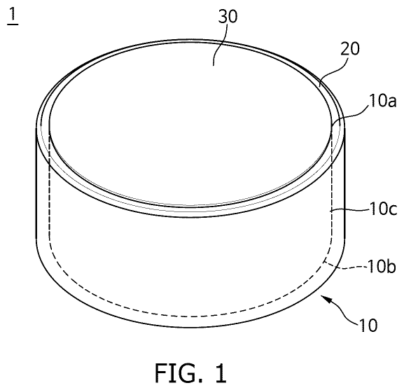

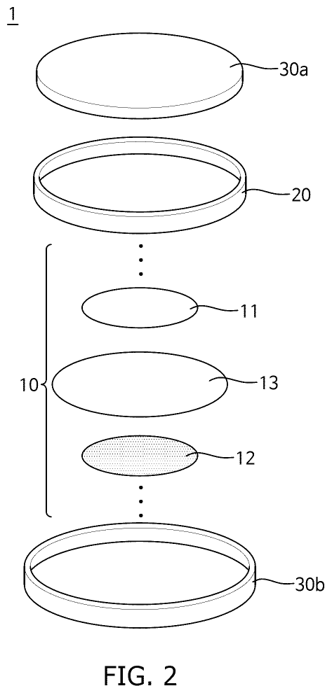

FIG. 1 is a perspective view of a secondary battery according to some embodiments of the present disclosure, and FIG. 2 is a schematic exploded perspective view of a secondary battery according to some embodiments of the present disclosure.

Referring to FIGS. 1 and 2, a secondary battery 1 according to embodiments of the present disclosure may include an electrode assembly 10, an insulating member 20, and a case 30.

A secondary battery according to one or more embodiments is a micro-sized secondary battery and may be a coin cell or a button cell. But the present disclosure is not limited to these examples and may be, for example, a cylindrical or pin-type battery.

The coin cell or button cell is a battery in the shape of a thin coin or button, and may refer to a battery in which the ratio of height to diameter (height/diameter) is 1 or less, but is not limited thereto. Because the coin cell or button cell is generally cylindrical, its cross section in the horizontal direction is generally circular. However, the cross section in the horizontal direction is not limited and may be, for example, an elliptical or polygonal shape. The diameter may refer to a maximum distance in the horizontal direction of the battery, and the height may refer to a maximum distance in the vertical direction of the battery (for example, a distance from the bottom surface to the top surface of the battery).

The electrode assembly 10 may be a stacked-type electrode assembly. The electrode assembly 10 may be formed by repeatedly stacking of an anode 11 or 12, a separator 13, a cathode 11 or 12, and a separator 13. That is, the electrode assembly 10 may include a plurality of anodes 11 or 12, separators 13, and cathodes 11 or 12 stacked vertically from the bottom of the case 30. The plurality of anodes 11 or 12, separators 13, and cathodes 11 or 12 may be stacked in the same arrangement in a first direction. In a plan view, the shape of the electrode assembly 10 may be similar to the shape of the case 30. In addition, electrode tabs (not shown) may extend from each of the plurality of cathode plates and anode plates included in the electrode assembly 10.

The separator 13 may include, for example, polyethylene, polypropylene, polyvinylidene fluoride, or a multilayer film of two or more layers thereof. The separator 13 may include a porous substrate and a coating layer including an organic material, an inorganic material, or a combination thereof on one or both surfaces of the porous substrate. The organic material may include, for example, a polyvinylidene fluoride-based polymer or a (meth)acrylic polymer. The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and a combination thereof, but the present disclosure is not limited to these examples. The organic material and the inorganic material may be mixed in one coating layer, or a coating layer including an organic material and a coating layer including an inorganic material may be stacked.

The electrode assembly 10 may include a first surface 10a and a second surface 10b opposite each other, and a side surface 10c connecting the first surface 10a and the second surface 10b. The first electrode 11 may be positioned on the first surface 10a of the electrode assembly 10. Meanwhile, the second electrode 12 may be positioned on the second surface 10b of the electrode assembly 10. That is, the first electrode 11 and the second electrode 12 may be formed on the first and second surfaces 10a and 10b that are opposite to each other.

In an embodiment, a current collector (not shown) including an electrode tab may be positioned on the side surface 10c of the electrode assembly 10.

The insulating member 20 may be formed so as to face the first electrode 11, and may be positioned at a location contacting the perimeter of the first surface 10a of the electrode assembly 10. A conduction hole may be formed at the center of the insulating member 20 to expose at least a portion of the first electrode 11 formed on the first surface 10a. The insulating member 20 may be in the shape of a gasket that seals the electrode assembly 10 and electrically insulates it. The insulating member 20 may be formed of a polymer resin material, for example, polyimide (PI). Alternatively, the insulating member 20 may be formed of a resin material such as polyethylene (PE), polypropylene (PP), or polyethylene terephthalate (PET).

The case 30 may accommodate the electrode assembly 10. In examples, the electrode assembly 10 occupies greater than or equal to 85% to less than 100% or greater than or equal to 90% to less than 100% of the inner space of the case 30.

The case 30 may include an upper case 30a and a lower case 30b. The upper case 30a may be positioned to face the first surface 10a of the electrode assembly 10.. The lower case 30b may be positioned to face the second surface 10b of the electrode assembly 10.

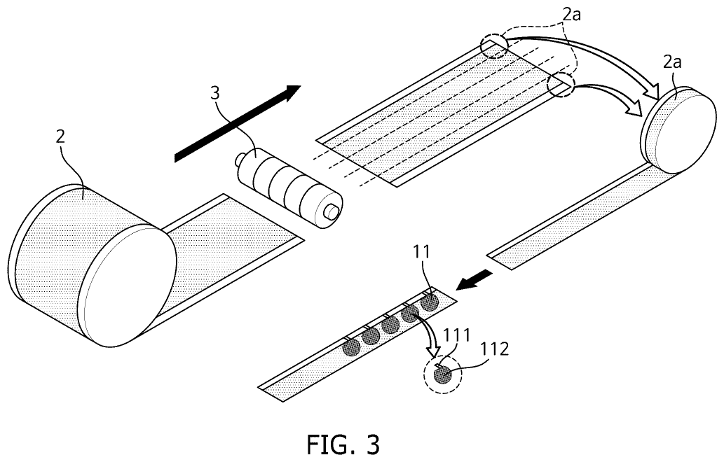

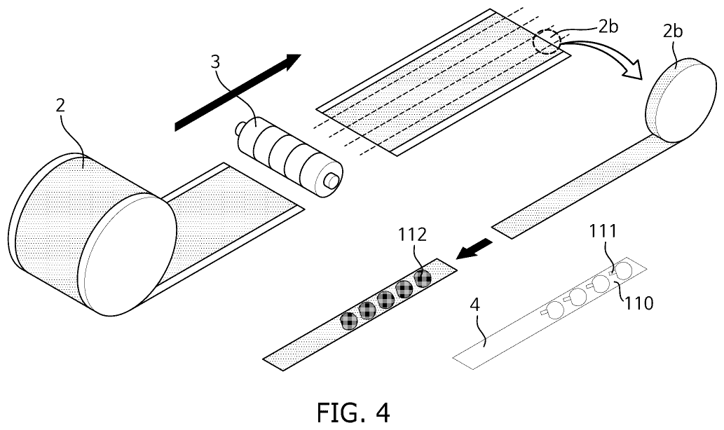

FIG. 3 illustrates a manufacturing process of a secondary battery according to a comparative example. FIG. 4 is a diagram illustrates a manufacturing process of a secondary battery according to some embodiments of the present disclosure.

According to a comparative example (related art) as illustrated in FIG. 3, in a process of manufacturing a stacked-type secondary battery among micro-sized secondary batteries, only a side electrode plate 2a may be used for the stacked-type secondary battery. The electrode plate 2 may include a coated portion in which a negative electrode active material or a positive electrode active material is coated on a substrate, and a non-coated portion where the negative electrode active material or positive electrode active material is not coated. Here, the substrate on which the positive electrode active material is coated may be formed from aluminum (Al), and the substrate on which the negative electrode active material is coated may be formed of copper (Cu). However, these are merely examples and the substrates may be formed from other materials.

To manufacture a micro-sized secondary battery, the coated electrode plate 2 is cut by a slitting device 3. Here, the non-coated portion of the electrode plate 2 may be located only on the side electrode plate 2a. In the micro-sized secondary battery according to the comparative example, a single electrode plate includes an electrode tab (which is a non-coated portion) and a coated portion. Accordingly, to manufacture a micro-sized, stacked-type secondary battery, only the side electrode plate 2a may be used. And because the secondary battery is micro-sized, there is a problem in that it is difficult to manufacture the electrode tab (non-coated portion) and the coated portion separately.

A punching process may be performed on the side electrode plate 2a to make a positive or negative electrode. That is, a circular first electrode 11 may be made from one side electrode plate 2a by the punching process. Here, the first electrode 11 may include a first electrode tab 111 as a non-coated portion and a first coating layer 112 as a coated portion. As described above, in the manufacturing process of a micro-sized, stacked-type secondary battery according to the comparative example, an electrode plate 2 other than the side electrode plate 2a cannot be used. Moreover, the smaller the secondary battery, the greater the loss of the electrode plate 2. Furthermore, because a single side electrode plate 2a contains both the first electrode tab 111 (non-coated portion) and the first coating layer 112 (coated portion), the cutting interval and the coating interval must be considered during the slitting process. This process is complex and there is a high probability of generating defects.

Referring to FIG. 4, an electrode of the secondary battery 1 according to the present disclosure may be manufactured using a center electrode plate 2b. The center electrode plate 2b has no non-coated portion and is coated with a positive electrode active material or a negative electrode active material. In an embodiment, a punching process is performed on the center electrode plate 2b to make a positive or negative electrode. Each of the center substrate 110, the first electrode 11, the second electrode 12, and the separator 13 may have a circular shape due to the punching process. And by the punching process, a circular first electrode 11 may be made from a single center electrode plate 2b. The first electrode 11 may be formed by applying the first coating layer 112 to the entirety of the punched area of the first electrode 11. The punching process may be performed on a thin electrode plate having no coating layer. By the punching process, the center substrate 110 (which is a non-coated portion) may be used to make the first electrode tab 111. Here, the punched center substrate 110 may have a circular shape in which the first electrode tab 111 protrudes. However, this is merely an example of the present disclosure, and various shapes such as a rectangular or elliptical shape, are possible.

According to embodiments of the present disclosure, in the manufacturing process of a micro-sized, stacked-type secondary battery, electrode plate 2 loss is reduced. Thus, manufacturing efficiency of the secondary battery 1 is improved.

Moreover, because the first electrode 11 or the second electrode 12 and the center substrate 110 are separately manufactured, the manufacturing process of the micro-sized, stacked-type secondary battery is simplified, and is not restricted by the size or shape of the electrodes and substrate. In addition, because the first electrode 11 or the second electrode 12 and the center substrate 110 are separately manufactured, wrinkling defects caused by differences in stress between the coated portion and the non-coated portion may be prevented. That is, defects caused by the process of coating an electrode active material on a substrate may be reduced.

The positive electrode active material may include a compound (lithiated intercalation compound) that may intercalate and deintercalate lithium. For example, at least one of a composite oxide of lithium and a metal selected from cobalt, manganese, nickel, and combinations thereof may be used.

The composite oxide may be a lithium transition metal composite oxide. Specific examples of the composite oxide may include a lithium nickel-based oxide, a lithium cobalt-based oxide, a lithium manganese-based oxide, a lithium iron phosphate-based compound, a cobalt-free nickel-manganese-based oxide, or a combination thereof.

As examples, the following compounds represented by any one of the following Chemical Formulas may be used: LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5, 0≤c≤0.5, and 0<α<2); LiaNi1-b-cMnbXcO2-αDα (0.90≤a≤1.8, 0≤b≤0.5, 0≤c≤0.5, and 0<α<2); LiaNibCocL1dGeO2(0.90≤a≤1.8, 0≤b≤0.9, 0≤c≤0.5, 0≤d≤0.5, and 0≤e≤0.1); LiaNiGbO2 (0.90≤a≤1.8 and 0.001≤b≤0.1); LiaCoGbO 2(0.90≤a≤1.8 and 0.001≤b≤0.1); LiaMn1-bGbO2 (0.90≤a≤1.8 and 0.001≤b≤0.1); LiaMn2GbO4 (0.90≤a≤1.8 and 0.001≤b≤0.1); LiaMn1-gGgPO4 (0.90≤a≤1.8 and 0≤g≤0.5); Li(3-f)Fe2(PO4)3 (0≤f≤2); or LiaFePO4 (0.90≤a≤1.8). In these Chemical Formulas, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a rechargeable lithium battery may include a current collector and a positive electrode active material layer on the current collector. The positive electrode active material layer may include a positive electrode active material and may further include a binder and/or a conductive material (e.g., an electrically conductive material).

An amount of the positive electrode active material may be about 90 wt% to about 99.5 wt% based on 100 wt% of the positive electrode active material layer. Amounts of the binder and the conductive material may be about 0.5 wt% to about 5 wt %, respectively, based on 100 wt% of the positive electrode active material layer.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, for example, crystalline carbon, amorphous carbon, or a combination thereof. The crystalline carbon may be graphite such as non-shaped, sheet-shaped, flake-shaped, sphere-shaped, or fiber-shaped natural graphite or artificial graphite. The amorphous carbon may be soft carbon, hard carbon, a mesophase pitch carbonization product, calcined coke, and the like.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy or a combination thereof. In the formula Si-Q, Q is selected from an alkali metal, an alkaline-earth metal, a Group 13 element, a Group 14 element (excluding Si), a Group 15 element, a Group 16 element, a transition metal, a rare earth element, and a combination thereof. The Sn-based negative electrode active material may include Sn, SnO2, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles.

The silicon-carbon composite may further include crystalline carbon. For example, the silicon-carbon composite may include a core including crystalline carbon and silicon particles and an amorphous carbon coating layer on the surface of the core.

The negative electrode for a rechargeable lithium battery may include a current collector and a negative electrode active material layer on the current collector. The negative electrode active material layer may include a negative electrode active material and may further include a binder and/or a conductive material (e.g., an electrically conductive material).

The negative electrode active material layer may include, for example, about 90 wt% to about 99 wt% of the negative electrode active material, about 0.5 wt% to about 5 wt% of the binder, and about 0 wt% to about 5 wt% of the conductive material.

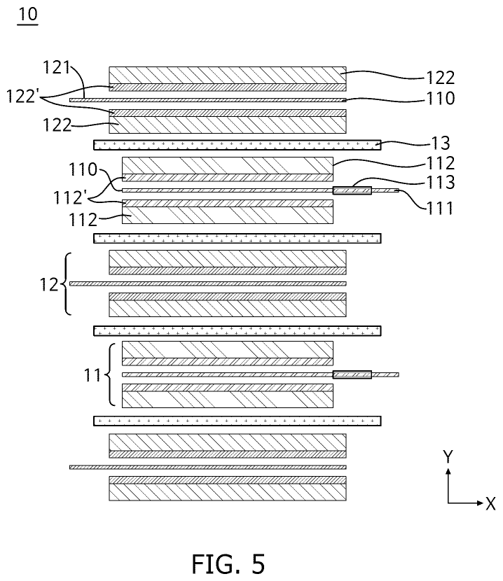

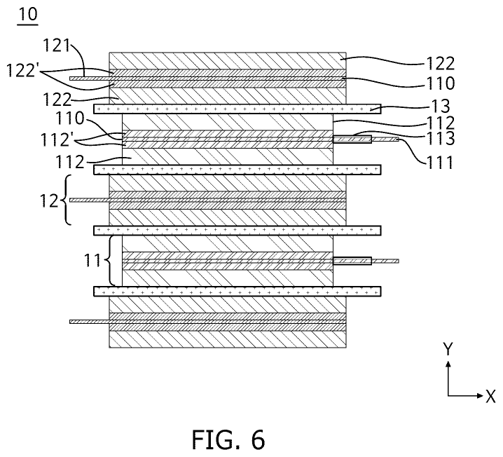

FIGS. 5 and 6 are cross-sectional views of an electrode assembly 10 according to embodiments of the present disclosure. FIGS. 5 and 6 illustrate an embodiment of the electrode assembly 10 included in the secondary battery 1 of FIGS. 1 and 2. Hereinafter, for ease of explanation, explanations focus on structures differing from the above-described secondary battery 1.

Referring to FIGS. 5 and 6, the electrode assembly 10 may be formed by stacking a first electrode 11, a separator 13, a second electrode 12, and a separator 13 in a first direction (for example, the Y direction shown in FIG. 5). In addition, the electrode assembly 10 may further include a center substrate 110, and the center substrate 110 may include electrode tabs 111 and 121.

Each of the first electrodes 11 may include a pair of first double layers, each including a first substrate 112′ and a first coating layer 112 disposed on the first substrate 112′. In addition, the first electrodes 11 may further include the center substrate 110 disposed between the pair of first double layers. Each of the second electrodes 12 may include a pair of second double layers, each including a second substrate 122′ and a second coating layer 122 disposed on the second substrate 122′. In addition, the second electrode 12 may further include the center substrate 110 disposed between the pair of second double layers.

The electrode assembly 10 may be stacked in the order of one first double layer, the center substrate 110, the other first double layer, the separator 13, one second double layer, the center substrate 110, and the other second double layer. Alternatively, the electrode assembly 10 may be stacked in the order of one second double layer, the center substrate 110, the other second double layer, the separator 13, one first double layer, the center substrate 110, and the other first double layer. However, these are merely examples and is the present disclosure is not limited thereto.

In another embodiment, the center substrate 110 may be separately provided rather than being included in the first electrode 11 or the second electrode 12.

The first double layer may be formed by applying the first coating layer 112 to a surface of the first substrate 112′. The first coating layer 112 may include a positive electrode active material or a negative electrode active material. That is, depending on the type of the first coating layer 112, the first electrode 11 including the first double layer may be a positive electrode or a negative electrode. The second double layer may be formed by applying the second coating layer 122 to a surface of the second substrate 122′. The second coating layer 122 may include a positive electrode active material or a negative electrode active material. That is, depending on the type of the second coating layer 122, the second electrode 12 including the second double layer may be a positive electrode or a negative electrode.

The center substrate 110 may include an electrode tab that is an extension of one end of the center substrate 110. In an embodiment, the electrode tab of the center substrate 110 may extend in a second direction (for example, the X or Z directions) that are perpendicular to the first direction (for example, the Y direction as shown in FIG. 5). For example, the first electrode tab 111 may extend in the +X direction, and the second electrode tab 121 may extend in the −X direction. That is, the first electrode tab 111 and the second electrode tab 121 may extend in opposite directions relative to the center substrate 110 in the X. However, this arrangement is merely an example and the present disclosure is not limited thereto.

The center substrate 110 may include an insulating portion 113. For example, if the first electrode 11 is a negative electrode, the insulating portion 113 may be formed as a polyimide (PI) film that is coated on a part of the first electrode tab 111. If the second electrode 12 is a positive electrode, part of the second electrode tab 121 may not include an insulating portion.

The center substrate 110 may be positioned between a first surface of a first substrate 112′ and a second surface of the first substrate 112′. Here, the second surface of the first substrate 112′ may be a surface on which the first coating layer 112 is not applied. The center substrate 110 may be positioned between a first surface of a second substrate 122′ and a second surface of the second substrate 122′. Here, the second surface of the second substrate 122′ may be a surface on which the second coating layer 122 is not applied. The thickness of the center substrate 110 may be less than the thickness of the first substrate 112′ and the second substrate 122′. For example, if the first substrate 112′ is a negative electrode substrate such as a copper substrate to which a negative electrode active material is applied, the thickness of the first substrate 112′ may be 8-10 μm. If the second substrate 122′ is a positive electrode substrate such as an aluminum substrate, the thickness of the second substrate 122′ may be 10−15 μm. With such first and second substrates 112′ and 122′, the thickness of the center substrate 110, which includes the electrode tab, may be at least 4 μm. But the present disclosure is not limited to this example. In addition, the first substrate 112′ and the center substrate 110 or the second substrate 122′ and the center substrate 110 may be adhered and stacked by the pressure applied to the electrode assembly 10.

The separator 13 may be positioned between the first electrode 11 and the second electrode 12. Specifically, the separator 13 may be positioned between the first coating layer 112 of the first electrode 11 and the second coating layer 122 of the second electrode 12.

When the first electrode 111 or the second electrode 121 and the center substrate 110 are separately manufactured as described above, the electrode assembly 10 according to the present disclosure may be stacked as illustrated in FIGS. 5 and 6. This stacked structure may prevent wrinkling defects due to a stress difference between the coated portion and the non-coated portion. That is, defects caused by the process of coating an electrode active material on a substrate may be reduced.

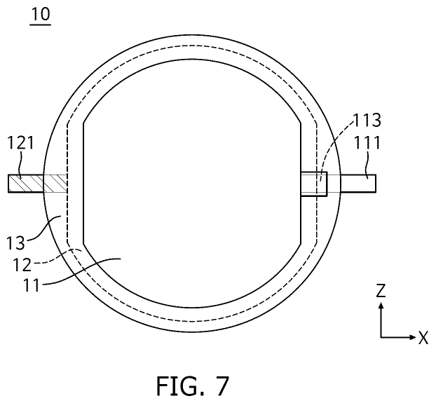

FIG. 7 is a top plan view of the electrode assembly 10 according to a first embodiment of the present disclosure. FIG. 7 depicts an embodiment of the electrode assembly 10 of FIGS. 5 and 6. Hereinafter, descriptions will be primarily directed to structures differing from the above-described secondary battery 1 and electrode assembly 10.

Referring to FIG. 7, the electrode assembly 10 may be stacked in the order of the first electrode 11, the separator 13, and the second electrode 12. Here, the first electrode 11 and the second electrode 12 may each have an area that is than the area of the separator 13.

The first electrode tab 111 may be positioned between the pair of first double layers, and the second electrode tab 121 may be positioned between the pair of second double layers. The first electrode tab 111 may extend in the +X direction, and the second electrode tab 121 may extend in the −X direction. That is, the first electrode tab 111 and the second electrode tab 121 may extend in opposite directions.

In an embodiment, the center substrate 110 may include a linear segment (or linear section, linear portion) on one side. That is, part of one end of the center substrate 110 may be formed as a straight line. Similar to the center substrate 110, part of one end of the first double layer (or the first substrate) and the second double layer (or the second substrate) may also be formed as a straight line. Here, the linear segment of the center substrate 110 may be where the first electrode tab 111 or the second electrode tab 121 is located. In other words, the center substrate 110 may be formed in a circular shape having a curved perimeter, with part of the curved perimeter may be modified into a straight line as shown in FIG. 7. Because the first electrode tab 111 and the second electrode tab 121 extend in opposite directions about the center substrate 110, each of the plurality of center substrates 110, first double layers, and second double layers may have straight lines formed at both ends. That is, each of the center substrate 110, the first electrode 11, and the second electrode 12 may have a straight perimeter at the an end where the first electrode tab 111 or the second electrode tab 121 is located.

Because the first electrode tab 111 and the second electrode tab 121 extend in opposite directions, the electrode assembly 10 may have a wider area for each of the first electrode 11, the separator 13, and the second electrode 12 compared to a conventional secondary battery electrode assembly. And when the first electrode tab 111 and the second electrode tab 121 extend in opposite directions, energy density may be increased.

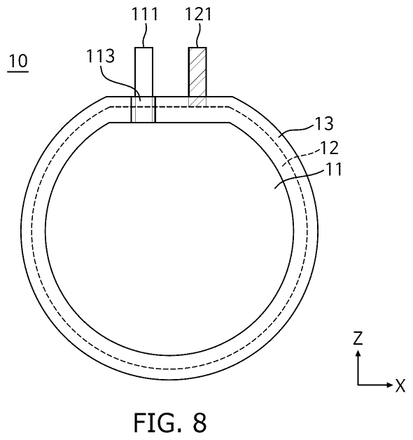

FIG. 8 is a top plan view of the electrode assembly 10 according to a second embodiment of the present disclosure. In the following, description will be primarily directed to differences from the embodiment described with respect to FIG. 7.

Referring to FIG. 8, the first electrode tab 111 may extend in the +Z direction and the second electrode tab 121 may also extend in the +Z direction. That is, the first electrode tab 111 and the second electrode tab 121 may extend in the same direction about the center substrate 110 in the Z direction. The first electrode tab 111 and the second electrode tab 121 may be stacked so as not to overlap each other in the same direction.

In an embodiment, part of one end of the center substrate 110 may be formed as a straight line. Similarly to the center substrate 110, part of one end of the first electrode 11, the second electrode 12, and the separator 13 may also be formed as a straight line. Here, the first electrode tab 111 and the second electrode tab 121 may each be located on the part formed as a straight line. For example, the center substrate 110 may be formed in a circular shape having a curved perimeter, with a part of the curved perimeter being modified to be a straight line as shown in FIG. 8. Because the first electrode tab 111 and the second electrode tab 121 extend in the same direction in the Z direction, each of the center substrate 110, the first electrode 11, the second electrode 12, and the separator 13 may have a straight line formed at one end. That is, each of the center substrate 110, the first electrode 11, the second electrode 12, and the separator 13 may have a straight perimeter at an end where the first electrode tab 111 and the second electrode tab 121 are located.

Although a part of the perimeter of the electrode assembly 10 is straight, the boundary edge of the electrode assembly 10 is still close to a circle. Accordingly, compared to a conventional secondary battery electrode assembly, the electrode assembly 10 may have improved energy density.

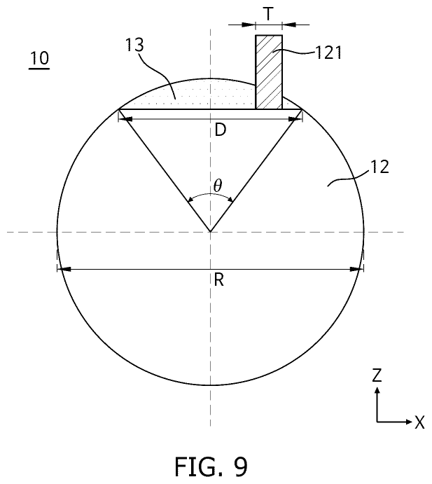

FIG. 9 is a more specific top plan view of the electrode assembly 10 according to embodiments of the present disclosure.

The center substrate 110 may include a linear segment on one side. Similar to the center substrate 110, part of one end of the first double layer and the second double layer may also be formed as a straight line. Here, the linear segment of the center substrate 110 may be where the first electrode tab 111 or the second electrode tab 121 is located.

As illustrated in FIG. 9, the center substrate 110 and the second electrode 12 may be formed as a circular shape having a curved perimeter. Because the electrode assembly 10 is an electrode assembly for the micro-sized secondary battery 1, the diameter of the center substrate 110 and the second electrode 12 may be 8-12 mm, and preferably the diameter may be 10 mm. However, these are merely examples and the present disclosure is not limited thereto.

Part of the curved perimeter of the center substrate 110 and the second electrode 12 may be formed as a segment (D). For example, the second electrode tab 121 may extend in the Z direction, and the center substrate 110 may have the segment (D) at one end where the second electrode tab 121 is located. The second double layer of the second electrode 12 may also have the segment (D) at one end where the second electrode tab 121 is located. Here, the length of the segment (D) may be 6.5-8.5 mm, and preferably 7.1 mm. In addition, the length of the segment (D) may be determined by the central angle (θ) shown in FIG. 9 and the thickness (T) of the second electrode tab 121. Preferably, the central angle (θ) of the segment (D) may be 60° to 90°, and the thickness T of the second electrode tab 121 may be 2.5 mm. But these are merely examples of the present disclosure and is not limited thereto.

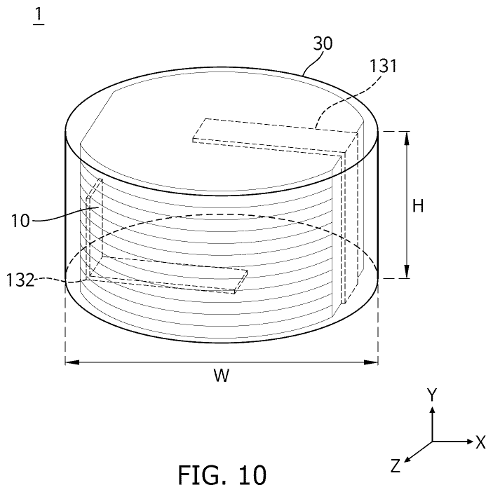

FIG. 10 is a perspective view of the secondary battery 1 according to embodiments of the present disclosure.

Referring to FIG. 10, the inner boundary of the case 30 may be circular, and more than half of the perimeter of the electrode assembly 10 may correspond to the circular arc or curved line of the case 30. Here, the size of the case 30 of the secondary battery 1 according to the present disclosure may be as follows: the height (H) in a first direction (the Y direction) may be 5-6 mm, and the width (W) in a second direction (the X direction) may be 10-15 mm. However, these are merely examples and the present disclosure is not limited thereto.

The remainder of the circular perimeter of the electrode assembly 10 may include a straight segment. Here, the straight segment denotes a portion having a straight side. For example, the proportion of the length of the straight segment in the total perimeter length of the electrode assembly 10 may be small. Accordingly, the length of the straight segment may not be large enough to substantially alter the circular overall shape of the perimeter of the electrode assembly 10. In addition, if there are multiple straight segments, each straight segment may be spaced apart from the other straight segments. As a result, although there are straight segments around the perimeter of the electrode assembly 10, the boundary edge of the electrode assembly 10 remains close to a circle. Thus, within the case 30, the region occupied by the electrode assembly 10 may be larger than that of a conventional electrode assembly. In other words, within the inner region of the case 190, the region occupied by the electrode may be greater than that of a conventional electrode assembly. Thus, the energy density of the electrode assembly 10 according to the present disclosure may be higher than that of a conventional electrode assembly.

A first current collector 131 of the first electrode and a second current collector 132 of the second electrode may be formed between the two straight segments and the case 30. That is, the first current collector 131 of the first electrode and the second current collector 132 of the second electrode may contact the two straight segments and be spaced apart from the case 30. Here, one of the first current collector 131 and the second current collector 132 may for the positive electrode, and the other may be a current collector for the negative electrode. The current collector of the positive electrode may refer to a current collector belonging to or in contact with the positive electrode, and the current collector of the negative electrode may refer to a current collector belonging to or in contact with the negative electrode.

In embodiments, the second current collector 132 may be positioned about 90° in a counterclockwise direction from the first current collector 131 or symmetrically opposite to the first current collector 131. One of the first current collector 131 and the second current collector 132 may contact an upper portion corresponding to the top layer of the electrode assembly 10, and the other may contact a lower portion corresponding to the bottom layer of the electrode assembly 10. Here, the upper current collector may be connected to the positive electrode, and the lower current collector may be connected to the negative electrode.

In a conventional electrode assembly, when the entire perimeter of the electrode assembly is circular, the edges of the first current collector 131 and the second current collector 132 may protrude, which causes problems. For example, the inner side of the case 30 that contacts the edges of the first current collector 131 and the second current collector 132 may be damaged. To prevent this, the electrode assembly 10 of the secondary battery 1 according to the present disclosure includes straight segments, thereby preventing damage caused by contact with the case 30. In addition, the electrode assembly 10 of the secondary battery 1 according to the present disclosure may have improved energy density compared to a conventional electrode assembly.

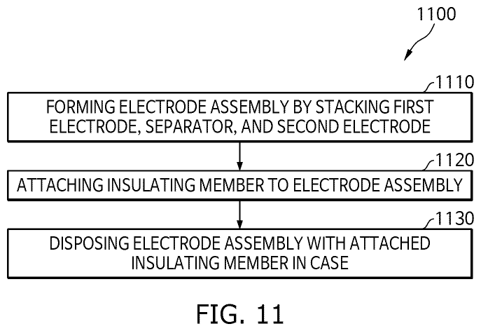

FIG. 11 is a flowchart of a method 1100 of manufacturing a secondary battery according to embodiments of the present disclosure.

The method 1100 described in FIG. 11 may be for manufacturing the secondary battery 1 of FIGS. 1 and 2.

The first electrode, separator, and second electrode may be stacked to form an electrode assembly 1110. For example, in the electrode assembly of FIG. 1, the first electrode, the separator, and the second electrode may be stacked in the first direction.

Then, the insulating member may be attached to the electrode assembly 1120. Subsequently, the electrode assembly with the attached insulating member may be placed in the case 1130. For example, the case of FIG. 1 may accommodate the electrode assembly, and the insulating member may be positioned between the electrode assembly and the case.

The first electrode 11 includes a pair of first double layers, each of which includes a first substrate 112′ and a first coating layer 112 disposed on the first substrate 112′. The first electrode 11 further includes the center substrate 110 disposed between the pair of first double layers. The second electrode 12 includes a pair of second double layers, each of which includes a second substrate 122′ and a second coating layer 122 disposed on the second substrate 122′, and the second electrode 12 further includes the center substrate 110 disposed between the pair of second double layers.

The center substrate 110 may include electrode tabs 111 and 121 in which the center substrate 110 extends at an end of the center substrate 110.

In an embodiment, forming the electrode assembly 1110 may include: preparing a first electrode plate (for example, the center electrode plate 2b of FIG. 4) by forming the first coating layer 112 on the first substrate 112′, and punching the first electrode plate to form the first double layer having a circular shape. Here, preparing the first electrode plate may include preparing an electrode plate (for example, the electrode plate 2 of FIG. 4) in which the first coating layer 112 is formed in a center region, and cutting the electrode plate to prepare the first electrode plate on which the first coating layer 112 is formed.

Forming the electrode assembly 1110 may include preparing a second electrode plate (for example, the center electrode plate 2b of FIG. 4) by forming the second coating layer 122 on the second substrate 122′. Forming the electrode assembly 1110 may further include punching the second electrode plate to form the second double layer having a circular shape. Here, preparing the second electrode plate may include preparing an electrode plate (for example, the electrode plate 2 of FIG. 4) in which the second coating layer 122 is formed in a center region and cutting the electrode plate to prepare the second electrode plate on which the second coating layer 122 is formed.

Forming the electrode assembly 1110 may include preparing a third electrode plate (for example, the substrate plate 4 of FIG. 4) on which no coating layer is formed. Forming the electrode assembly 1110 may further include punching the third electrode plate to form the center substrate 110. However, this is merely an example and the present disclosure is not limited thereto.

Although the present disclosure has been described above with respect to embodiments thereof, the present disclosure is not limited thereto. Various modifications and variations may be made thereto by those skilled in the art within the spirit of the present disclosure.

What is claimed is:

1. An secondary battery comprising:
a case;
an electrode assembly accommodated in the case, the electrode assembly including a first electrode, a separator, and a second electrode; and an insulating member positioned between the electrode assembly and the case,
wherein the first electrode comprises:
a pair of first double layers each including a first substrate and a first coating layer disposed on the first substrate; and
a first center substrate positioned between the pair of first double layers, and
wherein the second electrode comprises:
a pair of second double layers each including a second substrate and a second coating layer disposed on the second substrate; and
a second center substrate positioned between the pair of second double layers.

2. The secondary battery according to claim 1, wherein the first center substrate comprises a first electrode tab extending from an end of the first center substrate, and
wherein the second center substrate comprises a second electrode tab extending from an end of the second center substrate.

3. The secondary battery according to claim 2, wherein the first center substrate includes an insulating portion in which a polyimide (PI) film is coated on a part of the first electrode tab.

4. The secondary battery according to claim 2, wherein each of the first electrode, the second electrode, and the separator is circular shaped.

5. The secondary battery according to claim 4, wherein each of the first electrode and the second electrode has a surface area that is less than a surface area of the separator.

6. The secondary battery according to claim 5, wherein the first center substrate includes a first linear segment formed on one side,
wherein the second center substrate includes a second linear segment formed on one side,
wherein the first electrode tab is positioned to the first segment, and
wherein the second electrode tab is positioned to the second segment.

7. The secondary battery according to claim 6, wherein an angle formed between the first segment and the second segment is 60° to 90°.

8. The secondary battery according to claim 2, wherein the first electrode tab and the second electrode tab extend in opposite directions with respect to the first center substrate and the second center substrate.

9. The secondary battery according to claim 2, wherein the first electrode tab and the second electrode tab extend in same direction with respect to the first center substrate and the second center substrate.

10. The secondary battery according to claim 2, wherein the first electrode, the separator, and the second electrode are stacked in a first direction, and
wherein the first electrode tab and the second electrode tab extend in a second direction that is perpendicular to the first direction.

11. The secondary battery according to claim 1, wherein the electrode assembly is a stack-type electrode assembly, and
wherein the separator is positioned between the first coating layer of the first electrode and the second coating layer of the second electrode.

12. The secondary battery according to claim 1, wherein the first coating layer is disposed on first surfaces of the first substrates and the second coating layer is disposed on first surfaces of the second substrates,
wherein the first center substrate is positioned between second surfaces of the first substrates, and
wherein the second center substrate is positioned between second surfaces of the second substrates.

13. The secondary battery according to claim 1, wherein a thickness of the center substrate is less than a thickness of the first substrates and a thickness of the second substrates.

14. The secondary battery according to claim 1, wherein the secondary battery is a coin-type secondary battery or a button-type secondary battery.

15. A method for manufacturing a secondary battery, the method comprising:
forming an electrode assembly by stacking a first electrode, a separator, and a second electrode;
attaching an insulating member to the electrode assembly; and
disposing the electrode assembly with the attached insulating member in a case,
wherein the first electrode comprises:
a pair of first double layers each including a first substrate and a first coating layer disposed on the first substrate; and
a first center substrate positioned between the pair of first double layers, and
wherein the second electrode comprises:
a pair of second double layers each including a second substrate and a second coating layer disposed on the second substrate; and
a second center substrate positioned between the pair of second double layers.

16. The method according to claim 15, wherein the first center substrate comprises a first electrode tab extending from an end of the first center substrate, and
wherein the second center substrate comprises a second electrode tab extending from an end of the second center substrate.

17. The method according to claim 16, wherein forming the electrode assembly comprises:
preparing an electrode plate by forming the first coating layer on the first substrate; and
punching the electrode plate to form the pair of first double layers having a circular shape.

18. The method according to claim 17, wherein the first coating layer is formed in a center region of the electrode plate, and
wherein preparing the electrode plate comprises
cutting the electrode plate to prepare the first electrode plate having the first coating layer.

19. The method according to claim 17, wherein the electrode plate is a first electrode plate, and
wherein forming the electrode assembly comprises:
preparing a second electrode plate by forming the second coating layer on the second substrate; and
punching the second electrode plate to form the pair of second double layers having a circular shape.

20. The method according to claim 19, wherein forming the electrode assembly comprises:
preparing a third electrode plate on which no coating layer is formed; and
punching the third electrode plate to form the first center substrate and the second center substrate.
